(19) United States
(12) Patent Application Publication
(10) Pub. No.: US 2026/0064577 A1
(43) Pub. Date: Mar. 5, 2026

(54) AUTOMATED SELECTION OF APPLICATION TESTING TOOLS

(71) Applicant: Micro Focus LLC, Wilmington, DE (US)

(72) Inventors: Muyuan Li, Shanghai (CN); Xiaolong Liu, Shanghai (CN); Kun Wei, Shanghai (CN)

(73) Assignee: Micro Focus LLC, Wilmington, DE (US)

(21) Appl. No.: 18/822,606

(22) Filed: Sep. 3, 2024

(51) Int. Cl. G06F 11/36

(52) U.S. Cl. CPC G06F 11/3692; G06F 11/3688

(57) ABSTRACT

Systems and methods are disclosed for automatically analyzing an application under test (AUT) and, as a result of the analysis, determining a function of the AUT. The function may comprise a permission and/or a framework. An automated test is then selected, from a pool of tests, to test the function of the AUT. The test is then performed on the AUT. Results from the test may be provided back to the analysis process, which may be an artificial intelligence, such as a neural network, as feedback.

### FIELD OF THE DISCLOSURE

The invention relates generally to systems and methods for analyzing applications to determine the relevant testing tools required to evaluate the application and particularly relates to machine-based selection of the testing tools.

### BACKGROUND

Computer programs (applications) executed by at least one processor require testing to ensure that the instructions of the application work as intended and/or do not contain code that could be harmful to privacy or cause undesired, and otherwise unknown, operations. Applications may be developed by one party and tested by another. The testing party may not have access to the source code, which is often proprietary. Even when source code is provided, the testing party may not have all the libraries or other code to build the executable code from the source code. As a result, the executable code may contain alterations or flaws that are unknown to the testing party or even the author of the source code.

### SUMMARY

A large number of testing tools exist, and applications have the potential to be subject to tests of potentially all of them. Some of the tools may be relevant and test portions of the application, while other tools may not. Irrelevant tests would waste computing and other resources, such as when the tool initiates tests that are directed to a particular function that is not present in the application. Selecting a testing tool to perform a set of tests on functions that are absent from an application wastes processing and testing resources, especially when such tests may be selected for execution many times. Often tests are not performed exhaustively (with every possible combination of inputs and operations) but instead are tested with a set of tests selected to, within a high degree of certainty but not absolute certainty, conclude that the application is operating as intended and/or is absent malicious code. Wasting processing time on tests that perform no valid service may decrease the opportunity for other tests to be performed that could reveal flaws or vulnerabilities. However, it is also important to ensure all functions of the application are identified and tested. As a result, selecting the correct set of testing tools that test all functions present but that exclude those tools that would test absent functions can be essential to ensuring proper operation of the application and the absence of harmful or unintended code.

These and other needs are addressed by the various embodiments and configurations of the present invention. The present invention can provide a number of advantages depending on the particular configuration. These and other advantages will be apparent from the disclosure of the invention(s) contained herein.

In one embodiment, an analyzer is provided to an application under test (AUT) and determines the functions and/or functionality of the application and, in response, selects one or more testing tools (e.g., testing applications) for testing the AUT. As a result, the AUT is thoroughly tested and no functionality is untested or, optionally, functions that are capable of faulty or malicious code could be present (e.g., retesting previously tested features, testing of static text that may be low/no risk, etc., may be omitted as a matter of design choice). The AUT testing is limited to only those testing tools that will perform tests of existing functions of the AUT (e.g., loading a camera testing application, launching the camera testing application, spending resources executing the camera testing tool that cannot be simultaneously used by another application, and receiving a result indicating that no camera functions are present in the AUT are avoided).

In another embodiment, Artificial Intelligence (AI) is trained to analyze the AUT and determine from the code (one or more of the source code, machine code, build list, etc.) functions to be tested. The AI may then trigger the testing tools necessary to test the determined functions.

In another embodiment, the AUT is a mobile device (e.g., Android, iOS) application, and the functions comprise the framework(s) of the AUT. An application file (e.g., "*.ipa") is retrieved, such as by an AI, and parsed to determine the frameworks of the AUT. Testing tools are then selected based on the determined frameworks and deployed to test the AUT.

In some aspects, the techniques described herein relate to a system, including: a computing device including one or more processors coupled to a computer memory including instructions; and wherein the instructions cause the one or more processors to perform: generating a prompt identifying an application under test (AUT), specifying an analysis to determine features of the AUT, and an output of a testing tool corresponding to the features of the AUT; analyzing the AUT with an artificial intelligence (AI) in accordance with the prompt; receiving a report from the AI in response to the AI analyzing the AUT selecting a testing tool, from a pool of testing tools, to test the AI corresponding to the features of the AUT.

In some aspects, the techniques described herein relate to a system, further including executing the testing tool to test the AUT.

In some aspects, the techniques described herein relate to a system, further including providing a result from the testing tool testing the AUT back to the AI as a feedback input wherein the result indicates the result including a presence or absence of a testable feature by the testing tool.

In some aspects, the techniques described herein relate to a system, further including instructions to cause the one or more processors to perform: accessing an executable form of the AUT; and decompiling the executable form of the AUT to obtain a source code form of the AUT; and wherein analyzing the AUT includes analyzing the source code form of the AUT.

In some aspects, the techniques described herein relate to a system, further including instructions to cause the one or more processors to perform: accessing an executable package of the AUT; and unpacking the executable package of the AUT to obtain a configuration file of the AUT; and wherein analyzing the AUT includes analyzing the configuration file of the AUT.

In some aspects, the techniques described herein relate to a system, wherein the feature includes a permission to perform an operation controlled by a device executing the AUT.

In some aspects, the techniques described herein relate to a system, wherein the feature includes a framework of the AUT.

In some aspects, the techniques described herein relate to a system, wherein the testing tool includes at least one of a single test, a collection of tests, a configured set of tests of the testing tool, or a testing application.

In some aspects, the techniques described herein relate to a system, wherein the testing tool includes instructions to cause the one or more processors to: determine a content specific input needed for the testing tool; generate the content specific input; and execute the testing tool using the content specific input.

In some aspects, the techniques described herein relate to a system, wherein the content specific input includes at least one of an encoded visual input, encoded audio input, or an encoded radio frequency input.

In some aspects, the techniques described herein relate to a system, including: a computing device including one or more processors coupled to a computer memory including instructions; and wherein the instructions cause the one or more processors to perform: provide an application under test (AUT) to an artificial intelligence (AI) including a neural network trained to analyze the AUT to determine features of the AUT; analyzing the AUT by the AI; receiving a report from the AI in response to the AI analyzing the AUT selecting a testing tool, from a pool of testing tools, to test the AI corresponding to the features of the AUT.

In some aspects, the techniques described herein relate to a system, further including instructions to cause the one or more processors to perform training the neural network, including: collecting a set of applications under tests (AUTs) from a database; applying one or more transformations to each AUT including adding a function, removing a function, modifying a function, adding a permission, removing a permission, and modifying a permission to create a modified set of AUTs; creating a first training set including the collected set of AUTs, the modified set of AUTs, and a set of non-functional content; training the neural network in a first stage using the first training set; creating a second training set for a second stage of training including the first training set and non-functional content that is incorrectly detected as a function after the first stage of training; and training the neural network in the second stage using the second training set.

In some aspects, the techniques described herein relate to a system, further including executing the testing tool to test the AUT.

In some aspects, the techniques described herein relate to a system, further including providing a result from the testing tool testing the AUT back to the AI as a feedback input wherein the result indicates the result including a presence or absence of a testable feature by the testing tool.

In some aspects, the techniques described herein relate to a system, further including instructions to cause the one or more processors to perform: accessing an executable form of the AUT; and decompiling the executable form of the AUT to obtain a source code form of the AUT; and wherein analyzing the AUT includes analyzing the source code form of the AUT.

In some aspects, the techniques described herein relate to a system, further including instructions to cause the one or more processors to perform: accessing an executable package of the AUT; and unpacking the executable package of the AUT to obtain a configuration file of the AUT; and wherein analyzing the AUT includes analyzing the configuration file of the AUT.

In some aspects, the techniques described herein relate to a system, wherein the feature includes a permission to perform an operation controlled by a device executing the AUT.

In some aspects, the techniques described herein relate to a system, wherein the feature includes a framework of the AUT.

In some aspects, the techniques described herein relate to a system, wherein the testing tool includes at least one of a single test, a collection of tests, a configured set of tests of the testing tool, or a testing application.

In some aspects, the techniques described herein relate to a method for selecting a testing tool corresponding to a feature of an application under test (AUT), including: generating a prompt identifying the AUT, specifying an analysis for features of the AUT, and an output of a testing tool corresponding to the features of the AUT; analyzing the AUT with an artificial intelligence (AI) in accordance with the prompt; receiving a report from the AI in response to the AI analyzing the AUT selecting a testing tool, from a pool of testing tools, to test the AI corresponding to the features of the AUT.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases "at least one," "one or more," "or," and "and/or" are open-ended expressions that are both conjunctive and disjunctive in operation. For example, each of the expressions "at least one of A, B, and C," "at least one of A, B, or C," "one or more of A, B, and C," "one or more of A, B, or C," "A, B, and/or C," and "A, B, or C" means A alone, B alone, C alone, A and B together, A and C together, B and C together, or A, B, and C together.

The term "a" or "an" entity refers to one or more of that entity. As such, the terms "a" (or "an"), "one or more," and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a process flow in accordance with embodiments of the present disclosure;

FIG. 2 depicts a process in accordance with embodiments of the present disclosure;

FIG. 3 depicts a prompt in accordance with embodiments of the present disclosure;

FIG. 4 depicts a first output of an AI in accordance with embodiments of the present disclosure;

FIGS. 5A-5B depict a second output of an AI in accordance with embodiments of the present disclosure;

FIG. 6 depicts a process in accordance with embodiments of the present disclosure;

FIG. 7 depicts a system in accordance with embodiments of the present disclosure;

FIG. 8 depicts a process in accordance with embodiments of the present disclosure; and

FIG. 9 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

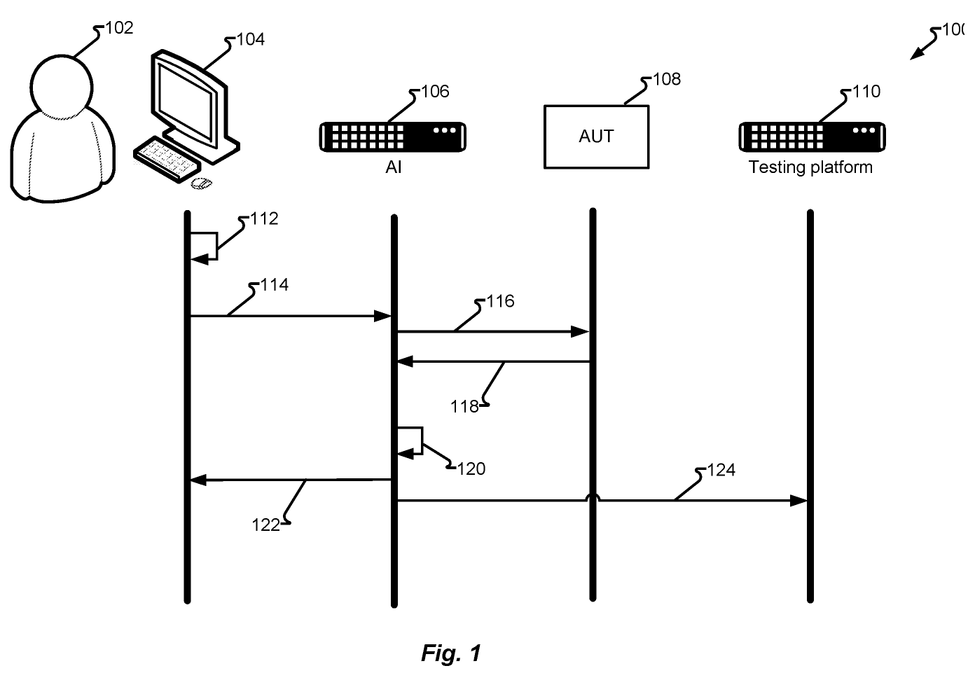

FIG. 1 illustrates system 100 in accordance with embodiments of the present disclosure. In one embodiment, user 102, using computer 104, creates prompt 112. In one embodiment, create prompt 112 generates a prompt comprising a subject, such as application under test (AUT) 108, an action to perform on the subject, such as analyze AUT 108, and a target result, such as to generate a list of test tools relevant to test AUT 108. Optionally, create prompt 112 may specify particular aspects of AUT 108 that should be tested. For example, user 102 may know that AUT 108 is planned to be deployed across a large number of locations and, therefore, the testing of for various locations, time zones, character sets, languages, etc., should be included and/or emphasized.

While embodiments herein discuss the selection or non-selection of a particular testing tool, it should be appreciated that the selection of particular tests or the configuration of a testing tool may be selected/non-selected without departing from the scope of the embodiments. For example, a testing tool may be selected as a particular configuration such as to more or less exhaustively test AUT 108.

In another embodiment, testing tools will not be selected if they only test features that are not present in AUT 108 and, if selected, would unnecessarily consume processing, data storage, and/or networking resources.

Step 114 provides the prompt to AI 106. It should be appreciated that AI 106 is illustrated as a single hardware component (e.g., a rack server) for convenience and that AI 106 comprises instructions executing on one or more, and likely many, hardware devices (e.g., graphical processing units (GPUs)).

In another embodiment, in step 116, AI 106 requests or otherwise accesses AUT 108 to receive AUT 108 in step 118. AUT 108 may be source code, machine code, built list, and/or combinations thereof. AUT 108, when embodied as source code, may not require additional processing. When AUT 108 is embodied as machine code, AUT 108 may be decompiled into source code or pseudo-source code. However, if AI 106 is able to understand machine code, decompiling AUT 108 may be omitted. Additionally or alternatively, AUT 108 may be, or comprise, a build list (e.g., libraries, resources, assets, etc.). As a further option, AUT 108 may comprise only a portion of an executable or a source code. For example, AUT 108 may be a particular feature of one or more applications and tested separately, such as before integration into the one or more applications. AUT 108 then analyzes AUT 108 in step 120.

AI 106 may be supervised, such as when user 102 and/or an automated prompt generation component generates a prompt to an AI that has been trained on a data set. The data set may include a number of prior AUTs, or portions thereof, and known relevant or non-relevant tests associated with the features of the AUTs. Accordingly, AI 106, when supervised, may determine that when a particular feature of the AUT is present, a particular test tool is then necessary to test the feature and select the particular test tool.

In another embodiment, AI 106 is an unsupervised AI, such as a general-purpose AI (e.g., an AI that is capable of responding to many types of requests across many domains). For example, an unsupervised AI may be provided with a large data set wherein patterns and/or anomalies are automatically detected. An unsupervised AI requires little or no training, beyond providing the training set. An unsupervised AI may discover patterns or relationships in the data set that were previously unknown. Alternatively, the AI may suffer from errors (e.g., hallucinations) when a perceived pattern or relationship is absent or a minor fact results in an over-weighted relationship (e.g., applications uploaded on Tuesdays always have a camera interface, applications uploaded on Wednesdays never use a microphone, etc.). An unsupervised AI generally requires feedback from a human or automated resource to correct the errors and/or acknowledge correct answers. The feedback is used to ensure that the reasoning utilized to produce hallucinations is identified as erroneous (or otherwise down-weighted) and the reasoning utilized to produce correct answers is reinforced (or otherwise up-weighted).

Returning to step 120, AI 106 processes the prompt on AUT 108 to produce a result, such as a list of one or more testing tools applicable to AUT 108. Step 122 notifies user 102 via computer 104, such as that the task is complete and/or to report the selected testing tools. Optionally, AI 106 notifies testing platform 110 in step 124 of the tests, such as to cause testing platform 110 to select (e.g., load, configure, initiate, etc.) the testing tools for testing AUT 108. As a further option, successfully passing the tests performed or initiated by testing platform 110 results in AUT 108 being made available for distribution, sale, or other use.

In another embodiment, testing platform 110 may provide feedback to AI 106, such as to confirm that selected testing tools were needed (e.g., AI 106 selected a camera testing tool and AUT 108 had camera features that were tested) and/or to correct a hallucination (e.g., AI 106 selected a camera testing tool and AUT 108 had no camera functionality). One hallucination may be determined when AI 106 selects a particular testing tool and, upon executing the particular testing tool, no substantive results are generated, such as only results indicating that the test was ran but no testable features existed for the particular testing tool to test. As a result, the indication of the absence of testable features may be provided as feedback to the AI.

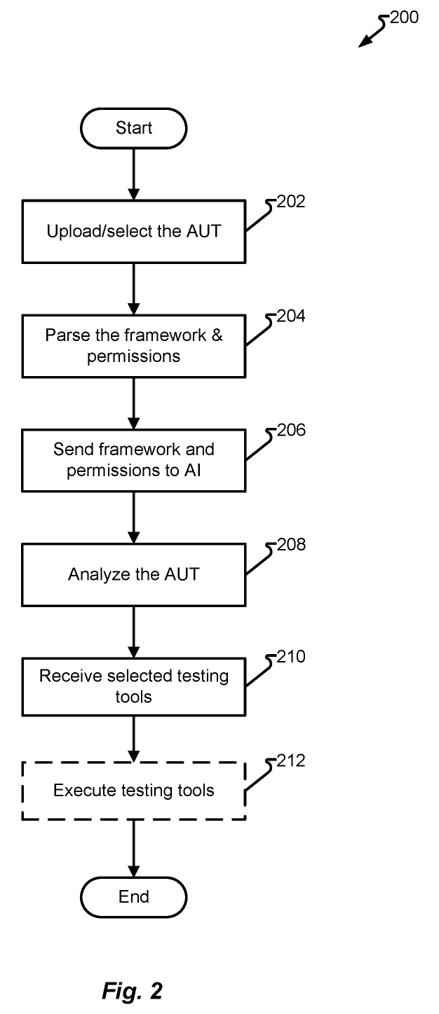

FIG. 2 illustrates process 200 in accordance with embodiments of the present disclosure. In one embodiment, process 200 is embodied as machine-readable instructions maintained in a non-transitory memory that when read by a machine (e.g., one or more processors of a computer, server, plurality of servers, etc.), cause the machine to execute the instructions and thereby execute process 200. The machine may include, but is not limited to, computer 104, AI 106, and testing platform 110.

In one embodiment, process 200 begins and, in step 202 a user (human or automated) uploads, selects, or otherwise identifies an AUT to an AI for analysis, such as user 102, via computer 104, identifying AUT 108 to AI 106. When the AI is untrained, step 202 may further comprise a prompt to request a particular type of analysis, the type of results requested, and/or other requirements. When the AI is trained to produce a list of testing tools when provided with an AUT, the prompt may be omitted or provided as a source for supplemental information (e.g., "emphasis multi-regional testing").

Step 204 parses the AUT, which may comprise parsing one or more files (e.g., *.IPA) and/or additional processing (e.g., unpacking, decompressing, decompiling, unzipping, etc.). Step 204 extracts the framework(s) of the AUT, such as functions/components (e.g., camera functions, GPS functions, etc.) and permissions, such as what features (e.g., data, components, etc.) of a client device will be accessed by the AUT. For example, the AUT may request permission to access the client device's address book and camera.

Step 206 then provides the framework and permissions to the AI and, in step 208, the AI analyzes the AUT. Step 208 may comprise providing the AUT to the AI, when the AI is trained (e.g., supervised) on training data, to recognize features (e.g., framework(s), permissions, code, libraries, etc.) and their corresponding testing tool. Step 208 may comprise analyzing the AUT in accordance with a prompt when the AI is an untrained (e.g., unsupervised) AI

Step 210 then receives the selected testing tools from the AI. Step 210 may report the selected testing tools to a user (e.g., user 102) and/or other system (e.g., testing platform 110). Step 210 may optionally report gaps or unknown features for which a testing tool may exist but is unknown to the AI. For example, the AUT may include a Structured Query Language (SQL) database operation however no SQL testing tool exists or is currently known to the AI. As a result, the AI may report the feature (e.g., SQL database operations) as untestable. As a further embodiment, the AI may have access to a data repository (e.g., GitHub, Google, etc.) and search for testing tools designed to test the currently untestable feature.

Optionally, step 212 executes the testing tools to test the AUT. The results of the testing tools may be provided back to the AI, when trained, as feedback related to the accuracy of the selected testing tools for the particular AUT analyzed in step 208.

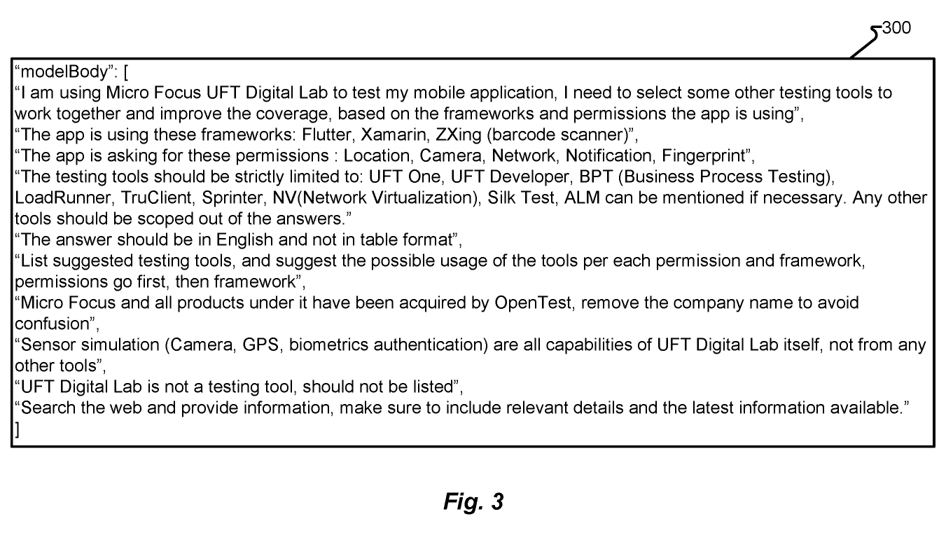

FIG. 3 illustrates prompt 300 in accordance with embodiments of the present disclosure. Prompt 300 illustrates one prompt, such as a prompt that may be human created (e.g., user 102), machine created (e.g., computer 104), or a combination thereof. For example, computer 104 may determine the frameworks and permissions (e.g., perform step 204 of FIG. 2) and provide recommendations for user 102 to accept or decline. Prompt 300 may designate or include the AUT or a portion of the AUT and any other instructions. Prompt 300 is then provided to an AI for execution.

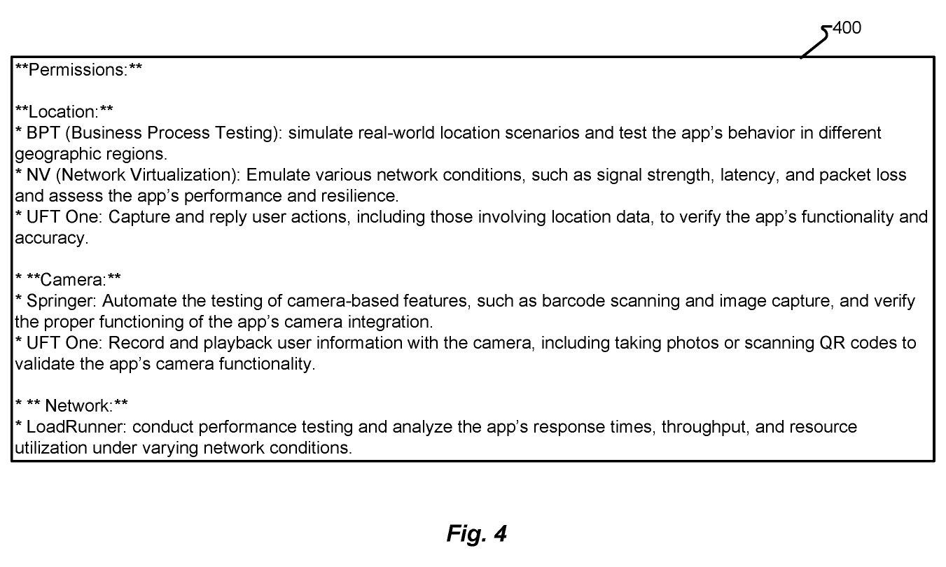

FIG. 4 illustrates AI response 400 in accordance with embodiments of the present disclosure. Response 400 illustrates one response from an AI identifying features and tests to perform to test the test features.

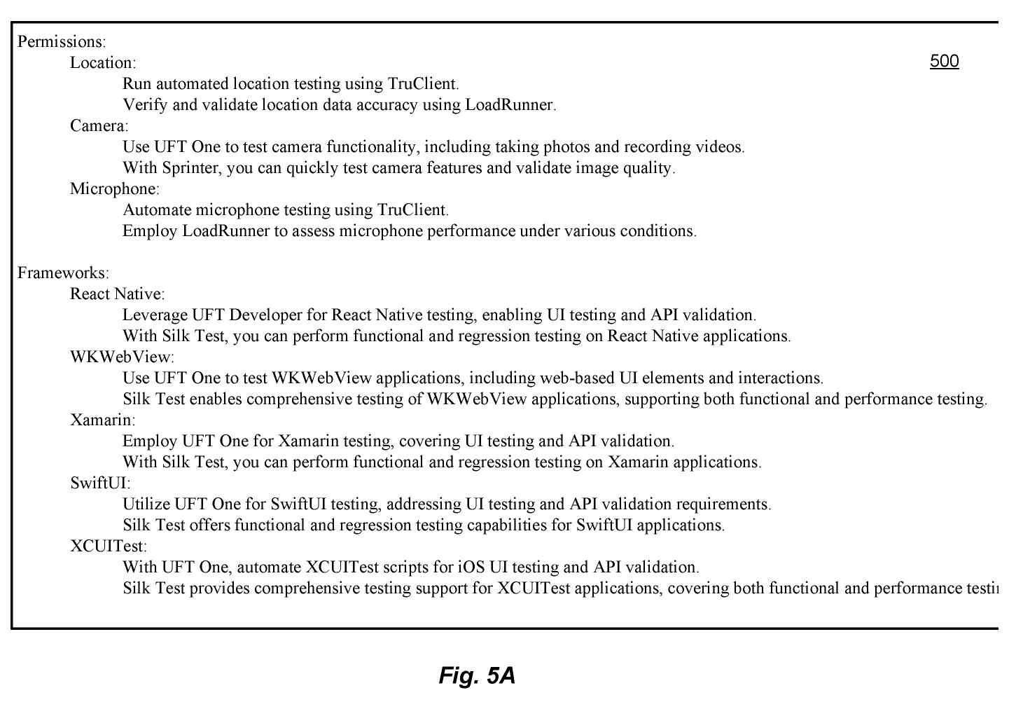

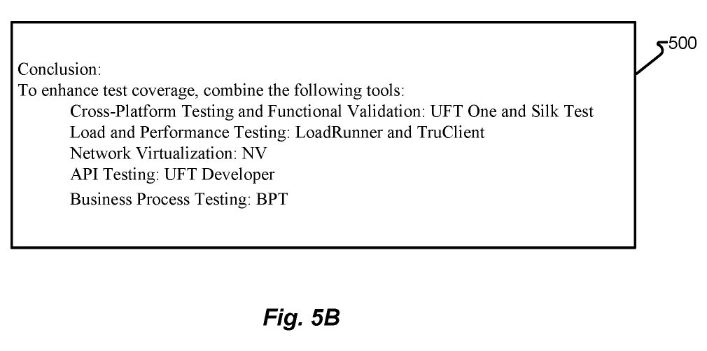

FIGS. 5A-5B illustrate AI response 500 in accordance with embodiments of the present disclosure. Response 500 illustrates one response from an AI identifying features and tests to perform to test the test features.

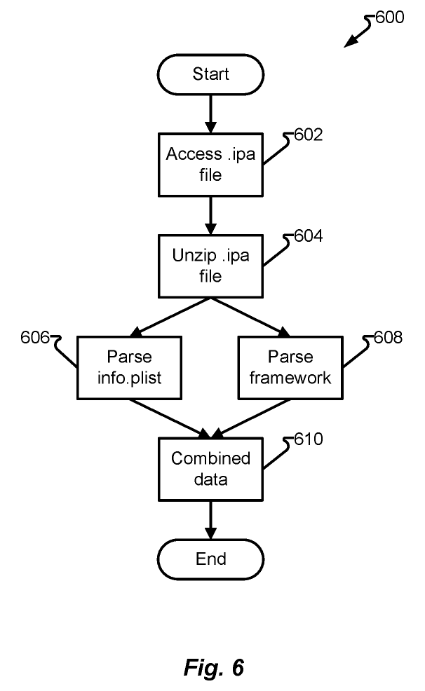

FIG. 6 depicts process 600 in accordance with embodiments of the present disclosure. In one embodiment, process 600 is embodied as machine-readable instructions maintained in a non-transitory memory that when read by a machine, such as one or more processors of a server or servers, cause the machine to execute the instructions and thereby execute process 600. The processor of the server may include, but is not limited to, at least one processor of a server, such a server executing AI 106, testing platform 110, computer 104, or combinations thereof.

Process 600 begins and, in step 602, accesses a machine code (e.g., an executable package), for example, an iOS archive file (".ipa"). Step 604 unpacks and/or unzips the machine code file and, therefrom, parses an information property list ("info.plist") file in step 606 and parses a complied machine code (framework) in step 608. A combined data 610 is then created for subsequent analysis of the functions therein. Combined data 610 captures, such as in one or more files or data records, what is to be tested (e.g., a particular AUT) and the features (e.g., frameworks, permissions, user requests, etc.) to be tested. Combined data 610 may be provided to an AI to determine the testing tools to test the AUT.

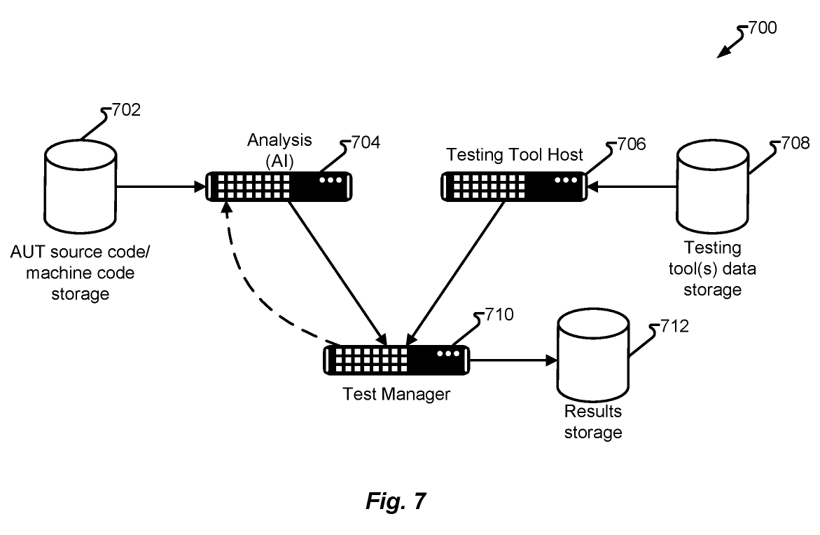

FIG. 7 illustrates system 700 in accordance with embodiments of the present disclosure. In one embodiment, system 700 illustrates computing components comprising analysis host 704, testing tool host 706, and test manager 710 and a data storage component interconnected, such as AUT code storage 702, testing tool data storage 708, and results storage 712 via a network. It should be appreciated that, in one embodiment, each of the illustrated components provides a single service. However, one of ordinary skill in the art will recognize that other topologies may be deployed without departing from the scope of embodiments herein. For example, any one component illustrated may be embodied as a plurality of components and/or any two or more components illustrated may be embodied as a single component. In one embodiment, the components as illustrated perform a single function; in other embodiments, one or more components may perform a plurality of functions and/or one or more functions may be performed by a plurality of components including as a service (e.g., software as a service (SaaS)).

In one embodiment, AUT storage 702, machine code, a configuration file, and/or a combination of any two or more of the foregoing for an application under test (AUT). The AUT is provided to analysis host 704. Analysis host 704 may also decompile or otherwise prepare or transform the file (e.g., one or more machine code files) for analysis by analysis host 704.

In one embodiment, analysis host 704 comprises an artificial intelligence, such as a neural network. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., a hyperplane) to delineate a combination of inputs that are active or inactive.

Analysis host 704 determines, from the source, machine code, and/or configuration file the functions of the AUT. Functions may be determined from the source code (e.g., a camera operation is performed by the AUT). Additionally or alternatively, the functions may comprise or be determined from permissions (e.g., the AUT asks for permissions to use a camera and, therefore, the functions of the AUT include camera operations). Additionally or alternatively, the functions may be identified from the configuration file (e.g., a camera software module is specified by the configuration file, therefore a camera function is present). Additionally or alternatively, the functions may be identified from a framework (e.g., a camera framework is specified by the configuration file, therefore a camera function is present).

In another embodiment, analysis host 704 identifies one or more testing tools associated with the functions of the AUT. Testing tool host 706 may perform an identification and retrieve and/or configure operations alone or with the benefit of testing tool data storage 708. For example, analysis host 704 may determine a camera testing tool is required and testing tool host 706 then configures and/or runs the camera testing tool.

In another embodiment, analysis host 704 identifies the testing tools necessary to test the AUT (e.g., the source and/or machine code and/or configuration file of the AUT). Analysis host 704 may determine non-functional content, which may be synonymous with functions that are known to not require testing by any testing tool, such as the presentation of static text. In one embodiment, all functions of the AUT, other than the identified non-functional content, is required to be tested by at least one testing tool.

In another embodiment, test manager 710 executes or otherwise causes the AUT to be evaluated by the selected testing tools identified by analysis host 704. Selecting of a testing tool(s) may be from a pool of testing tools (e.g., all available testing tools). The results may then be provided to results storage 712 and/or another user. Results may also be provided back to analysis host 704 (illustrated by the dashed line) as feedback, such as to the neural network. For example, if analysis host 704 identifies a particular testing tool as being necessary to test a feature identified in the AUT, but the results from the execution of the selected testing tool revealed no results, the result (e.g., a null result) or indicum of the results is provided back to analysis host 704 as feedback that the AUT did not include the erroneously identified function. The initial training set may be all inclusive, random (e.g., a "monkey" test), or trained with prior training sets and modifications (see process 400) and/or other training data.

In another embodiment, testing the AUT comprises determining a content specific input that is needed for the testing tool. For example, a visual input (e.g., an image, a quick-response (QR) code, a barcode, data in encoded light signals, etc.) may be required in order to perform at least one test of at least one testing tool. In another example, an audio input (e.g., speech, tone, etc.) may be generated in order to perform at least one test of at least one testing tool. In another example, a radio frequency input (e.g., cellular, Bluetooth, WiFi, GPS, NFC, etc.) may be generated in order to perform at least one test of at least one testing tool.

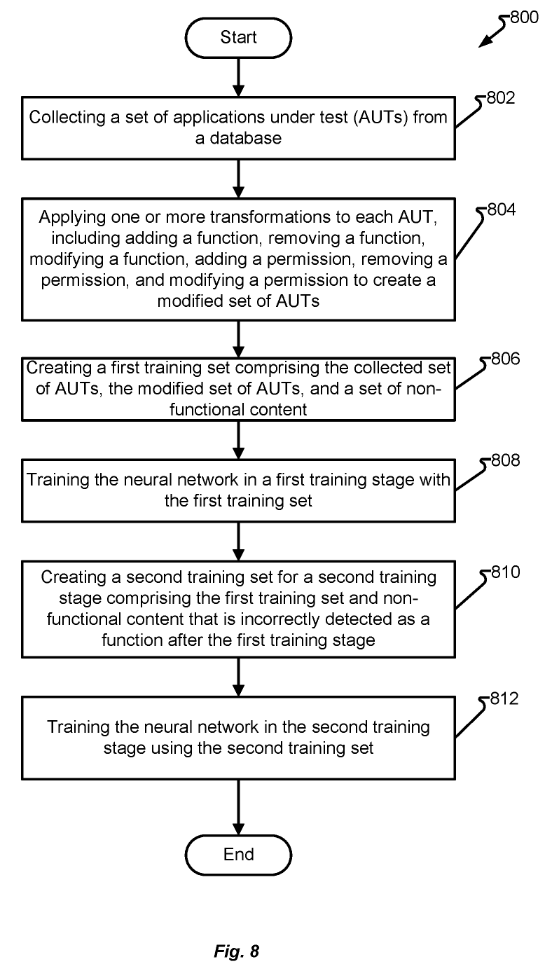

FIG. 8 depicts process 800 in accordance with embodiments of the present disclosure. In one embodiment, process 800 is embodied as machine-readable instructions maintained in a non-transitory memory that when read by a machine, such as one or more processors of a server or servers, cause the machine to execute the instructions and thereby execute process 800. The processor of the server may include, but is not limited to, at least one processor of a server, such as computer 104, AI 106, testing platform 110, analysis host 704, testing tool host 706, test manager 710, or a combination of any two or more of the foregoing.

In one embodiment, process 800 begins and, in step 802, a set of applications under test (AUTs) are collected from a database. Step 804 then applies one or more transformations to each AUT to create additional variations in the training set provided to the neural network. Such variations in the training set create synthetic training data to provide broader training data and reduce hallucinations in the neural network's logic. Step 804 performs transformations that including adding a function, removing a function, modifying a function, adding a permission, removing a permission, and modifying a permission to create a modified set of AUTs. Step 806 creates a first training set comprising the collected set of AUTs, the modified set of AUTs, and a set of non-functional content.

Step 808 trains the neural network in a first training stage using the first training set. Step 810 creates a second training set for a second training stage comprising the first training set and non-functional content that is incorrectly detected as a function after the first training stage. Step 812 trains the neural network in the second training stage using the second training set.

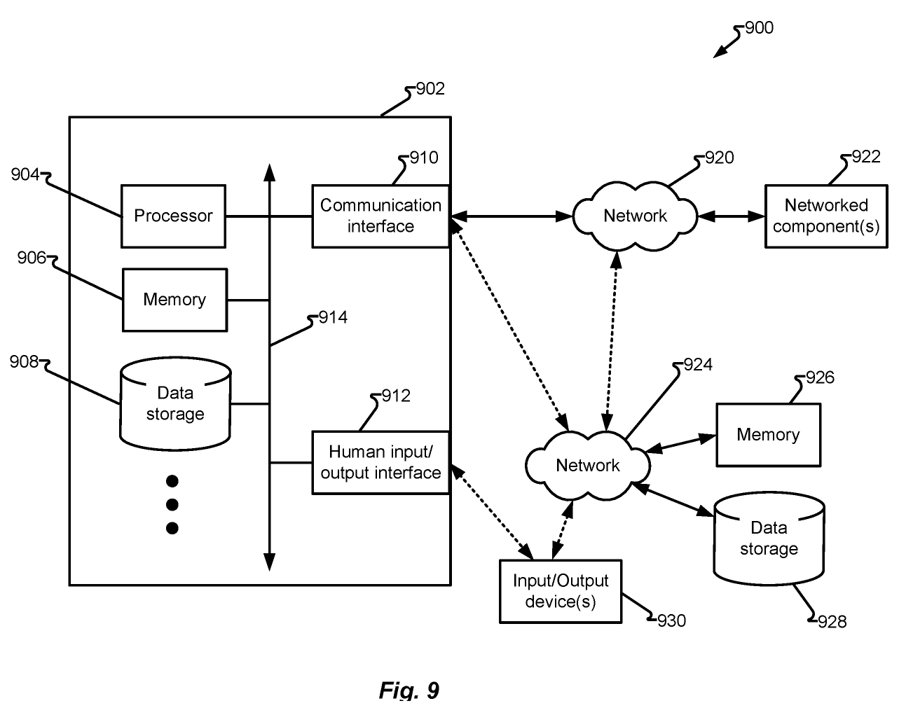

FIG. 9 depicts device 902 in system 900 in accordance with embodiments of the present disclosure. In one embodiment, computer 104, AI 106, testing platform 110, analysis host 704, testing tool host 706, test manager 710, analysis host 704, testing tool host 706, and/or test manager 710 or combinations thereof, may be embodied, in whole or in part, as device 902 comprising various components and connections to other components and/or systems. The components are variously embodied and may comprise processor 904. The term "processor," as used herein, refers exclusively to electronic hardware components comprising electrical circuitry with connections (e.g., pin-outs) to convey encoded electrical signals to and from the electrical circuitry. Processor 904 may comprise programmable logic functionality, such as determined, at least in part, from accessing machine-readable instructions maintained in a non-transitory data storage, which may be embodied as circuitry, on-chip read-only memory, computer memory 906, data storage 908, etc., that cause the processor 904 to perform the steps of the instructions. Processor 904 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 914, executes instructions, and outputs data, again such as via bus 914. In other embodiments, processor 904 may comprise a shared processing device that may be utilized by other processes and/or process owners, such as in a processing array within a system (e.g., blade, multi-processor board, etc.) or distributed processing system (e.g., "cloud", farm, etc.). It should be appreciated that processor 904 is a non-transitory computing device (e.g., electronic machine comprising circuitry and connections to communicate with other components and devices). Processor 904 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 904). Processor 904 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 904, device 902 may utilize computer memory 906 and/or data storage 908 for the storage of accessible data, such as instructions, values, etc. Communication interface 910 facilitates communication with components, such as processor 904 via bus 914 with components not accessible via bus 914 and may be embodied as a network interface (e.g., ethernet card, wireless networking components, USB port, etc.). Communication interface 910 may be embodied as a network port, card, cable, or other configured hardware device. Additionally or alternatively, human input/output interface 912 connects to one or more interface components to receive and/or present information (e.g., instructions, data, values, etc.) to and/or from a human and/or electronic device. Examples of input/output devices 930 that may be connected to input/output interface include, but are not limited to, keyboard, mouse, trackball, printers, displays, sensor, switch, relay, speaker, microphone, still and/or video camera, etc. In another embodiment, communication interface 910 may comprise, or be comprised by, human input/output interface 912. Communication interface 910 may be configured to communicate directly with a networked component or configured to utilize one or more networks, such as network 920 and/or network 924.

Network 920 may be a wired network (e.g., Ethernet), wireless (e.g., WiFi, Bluetooth, cellular, etc.) network, or combination thereof and enable device 902 to communicate with networked component(s) 922. In other embodiments, network 920 may be embodied, in whole or in part, as a telephony network (e.g., public switched telephone network (PSTN), private branch exchange (PBX), cellular telephony network, etc.).

Additionally or alternatively, one or more other networks may be utilized. For example, network 924 may represent a second network, which may facilitate communication with components utilized by device 902. For example, network 924 may be an internal network to a business entity or other organization, whereby components are trusted (or at least more so) than networked components 922, which may be connected to network 920 comprising a public network (e.g., Internet) that may not be as trusted.

Components attached to network 924 may include computer memory 926, data storage 928, input/output device(s) 930, and/or other components that may be accessible to processor 904. For example, computer memory 926 and/or data storage 928 may supplement or supplant computer memory 906 and/or data storage 908 entirely or for a particular task or purpose. As another example, computer memory 926 and/or data storage 928 may be an external data repository (e.g., server farm, array, "cloud," etc.) and enable device 902, and/or other devices, to access data thereon. Similarly, input/output device(s) 930 may be accessed by processor 904 via human input/output interface 912 and/or via communication interface 910 either directly, via network 924, via network 920 alone (not shown), or via networks 924 and 920. Each of computer memory 906, data storage 908, computer memory 926, data storage 928 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 930 may be a router, a switch, a port, or other communication component such that a particular output of processor 904 enables (or disables) input/output device 930, which may be associated with network 920 and/or network 924, to allow (or disallow) communications between two or more nodes on network 920 and/or network 924. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), "cloud", multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., "cloud" based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as "the cloud," but may include a public, private, dedicated, shared and/or other service bureau, computing service, and/or "server farm."

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, "cloud" or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable "source code" software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a computing device comprising one or more processors coupled to a computer memory comprising instructions; and
wherein the instructions cause the one or more processors to perform:
generating a prompt identifying an application under test (AUT), specifying an analysis to determine features of the AUT, and an output of a testing tool corresponding to the features of the AUT;
analyzing the AUT with an artificial intelligence (AI) in accordance with the prompt; and
receiving a report from the AI in response to the AI analyzing the AUT selecting the testing tool, from a pool of testing tools, to test the AI corresponding to the features of the AUT.

2. The system of claim 1, further comprising executing the testing tool to test the AUT.

3. The system of claim 2, further comprising providing a result from the testing tool testing the AUT back to the AI as a feedback input wherein the result indicates the result comprising a presence or absence of a testable feature by the testing tool.

4. The system of claim 1, further comprising instructions to cause the one or more processors to perform:
accessing an executable form of the AUT; and
decompiling the executable form of the AUT to obtain a source code form of the AUT; and
wherein analyzing the AUT comprises analyzing the source code form of the AUT.

5. The system of claim 1, further comprising instructions to cause the one or more processors to perform:
accessing an executable package of the AUT; and
unpacking the executable package of the AUT to obtain a configuration file of the AUT; and
wherein analyzing the AUT comprises analyzing the configuration file of the AUT.

6. The system of claim 1, wherein the features of the AUT comprises a permission to perform an operation controlled by a device executing the AUT.

7. The system of claim 1, wherein the features of the AUT comprises a framework of the AUT.

8. The system of claim 1, wherein the testing tool comprises at least one of a single test, a collection of tests, a configured set of tests of the testing tool, or a testing application.

9. The system of claim 1, wherein the testing tool comprises instructions to cause the one or more processors to:
determine a content specific input needed for the testing tool;
generate the content specific input; and
execute the testing tool using the content specific input.

10. The system of claim 9, wherein the content specific input comprises at least one of an encoded visual input, encoded audio input, or an encoded radio frequency input.

11. A system, comprising:
a computing device comprising one or more processors coupled to a computer memory comprising instructions; and
wherein the instructions cause the one or more processors to perform:
providing an application under test (AUT) to an artificial intelligence (AI) comprising a neural network trained to analyze the AUT to determine features of the AUT;
analyzing the AUT by the AI; and
receiving a report from the AI in response to the AI analyzing the AUT selecting a testing tool, from a pool of testing tools, to test the AI corresponding to the features of the AUT.

12. The system of claim 11, further comprising instructions to cause the one or more processors to perform training the neural network, comprising:
collecting a set of applications under tests (AUTs) from a database;
applying one or more transformations to each AUT including adding a function, removing a function, modifying a function, adding a permission, removing a permission, and modifying a permission to create a modified set of AUTs;
creating a first training set comprising the collected set of AUTs, the modified set of AUTs, and a set of non-functional content;
training the neural network in a first stage using the first training set;
creating a second training set for a second stage of training comprising the first training set and non-functional content that is incorrectly detected as a function after the first stage of training; and
training the neural network in the second stage using the second training set.

13. The system of claim 11, further comprising executing the testing tool to test the AUT.

14. The system of claim 13, further comprising providing a result from the testing tool testing the AUT back to the AI as a feedback input wherein the result indicates the result comprising a presence or absence of a testable feature by the testing tool.

15. The system of claim 11, further comprising instructions to cause the one or more processors to perform:
accessing an executable form of the AUT; and
decompiling the executable form of the AUT to obtain a source code form of the AUT; and
wherein analyzing the AUT comprises analyzing the source code form of the AUT.

16. The system of claim 11, further comprising instructions to cause the one or more processors to perform:
accessing an executable package of the AUT; and
unpacking the executable package of the AUT to obtain a configuration file of the AUT; and
wherein analyzing the AUT comprises analyzing the configuration file of the AUT.

17. The system of claim 11, wherein the features of the AUT comprises a permission to perform an operation controlled by a device executing the AUT.

18. The system of claim 11, wherein the features of the AUT comprises a framework of the AUT.

19. The system of claim 11, wherein the testing tool comprises at least one of a single test, a collection of tests, a configured set of tests of the testing tool, or a testing application.

20. A method for selecting a testing tool corresponding to features of an application under test (AUT), comprising:
generating a prompt identifying the AUT, specifying an analysis for the features of the AUT, and an output of the testing tool corresponding to the features of the AUT;
analyzing the AUT with an artificial intelligence (AI) in accordance with the prompt; and
receiving a report from the AI in response to the AI analyzing the AUT selecting the testing tool, from a pool of testing tools, to test AI corresponding to the features of the AUT.
